(19) United States
(12) Patent Application Publication
(10) Pub. No.: US 2014/0364239 A1
(43) Pub. Date: Dec. 11, 2014

(54) METHOD AND SYSTEM FOR CREATING A VIRTUAL SOCIAL AND GAMING EXPERIENCE

(71) Applicant: ICELERO INC, San Jose, CA (US)

(72) Inventors: Amit Ramchandran, San Jose, CA (US); Amir Masoud Zarkesh, Saratoga, CA (US); Mohammed Hamed Firooz, Mountain View, CA (US)

(21) Appl. No.: 14/364,244

(22) PCT Filed: Dec. 19, 2012
(86) PCT No.: PCT/US12/70688

§ 371 Date: Jun. 10, 2014

Related U.S. Application Data
(60) Provisional application No. 61/577,719, filed on Dec. 20, 2011.

(51) Int. Cl. A63F 13/87; H04L 29/06; A63F 13/33

(52) U.S. Cl. CPC A63F 13/87; A63F 13/33; H04L 65/403; H04L 67/42
USPC 463/42

(57) ABSTRACT

A system, method and computer program product for multi-player video gaming or chatting, including a virtual representation of a user, wherein the virtual representation of the user is configured for being displayed and used on a computer device in place of the user during online and/or offline video gaming, chatting, and/or virtual social interactions.

### CROSS REFERENCE TO RELATED DOCUMENTS

The present invention claims benefit of priority to U.S. Provisional Patent Application Ser. No. 61/577,719 of Amit RAMCHANDRAN et al., entitled “A PROCESS OF CREATING A VIRTUAL SOCIAL AND GAMING EXPERIENCE,” filed on Dec. 20, 2011, the entire disclosure of which is hereby incorporated by reference herein.

### BACKGROUND OF THE INVENTION

1. Field of the Invention

The present invention generally relates to systems and methods for video gaming, and more particularly to systems and methods for multi-player video gaming, chatting, and the like.

2. Discussion of the Background

In recent years, systems and methods for multi-player video gaming and/or communication between two or more persons over any suitable communications system, for example, including wired, wireless and mobile networks, and the like, have been developed. However, such systems and methods have been hindered by various problems, for example, including problems related to simultaneous game play and communications, problems related to communications network connection characteristics, problems related to variance in gaming device characteristics, and the like.

### SUMMARY OF THE INVENTION

Therefore, there is a need for methods and systems that address the above and other problems with video gaming systems and methods. Accordingly, the above and other needs are addressed by the illustrative embodiments of the present invention, which provide a novel method and system for multi-player video gaming, including creating a virtual representation of a player (or e.g., a chatter) referred to as a proxy-player (or e.g., proxy-chatter), based on the player's gaming (or e.g., chatting), social interaction, and/or other suitable characteristics, and the like. The proxy-player (or e.g., proxy-chatter) can be downloaded into any suitable gaming (or e.g., chatting) device, and the like, and compete (or e.g., chat) with real players (or e.g., real chatters) or other proxy-players (or e.g., proxy-chatters) at any suitable time, at any suitable, place, and the like. Advantageously, the systems and methods provide a highly responsive, continuous, and enjoyable multi-player gaming experience, and the like, as compared to conventional video gaming systems and methods, and can also be applied to online social interactions, other suitable gaming applications, including online chatting, and the like.

Accordingly, in an illustrative aspect, there is provided a system, method and computer program product for multi-player video gaming or chatting, including a virtual representation of a user. The virtual representation of the user can be configured for being displayed and used on a computer device in place of the user during online and/or offline video gaming, chatting, and/or virtual social interactions.

The virtual representation of the user is downloaded into a gaming or chatting device to compete or chat on behalf of the user with other real players or other virtual representations of other users.

The virtual representation of the user can be a virtual player in a video game or a virtual chatter in a chatting program.

The virtual player or the virtual chatter can be based on gaming and/or social characteristics of the user.

The virtual representation of the user can be applied to online social interactions, gaming applications, and/or online chatting.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative diagram for systems and methods for creating a virtual social and gaming experience;

FIG. 2 is an illustrative diagram for systems and methods that monitor and track strengths and weaknesses of a user playing a game (or e.g., chat) and that can store such information locally on a device or on a cloud environment;

FIG. 3 is an illustrative diagram for systems and methods that allow a proxy-player (or e.g., proxy-chatter) to be influenced by other online profiles of a user, such as social networking data, movies and music interests, and Internet browsing, and the like;

FIG. 4 is an illustrative diagram for systems and methods that allow output of analytics software to be used as an input to a recommendation engine, and the like, that employs personal information of a user as an input;

FIG. 5 is an illustrative diagram for systems and methods that that allow a proxy-player (or e.g., a proxy-chatter) to be used when a network connection is unacceptable, such that when the connection is recovered, a real player (or e.g., chatter) can be merged back instead of the proxy-player (or e.g., the proxy-chatter); and

FIG. 6 is an illustrative diagram for systems and methods for updating a proxy-player (or e.g., a proxy-chatter).

### DETAILED DESCRIPTION OF THE PREFERRED EMBODIMENTS

The present invention includes recognition that multi-player video gaming and/or communication between two or more persons over any suitable communications system including wired, wireless and mobile networks, and the like, is hindered by various factors, for example, including (1) the availability of two or more persons to simultaneously play a game or communicate; (2) individual device connection characteristics (e.g., speed, latency, etc.); and (3) variations in device characteristics (e.g., gaming on personal computers (PCs) versus PlayStation 3 (PS3) platforms versus. iPhone devices, etc.), and the like.

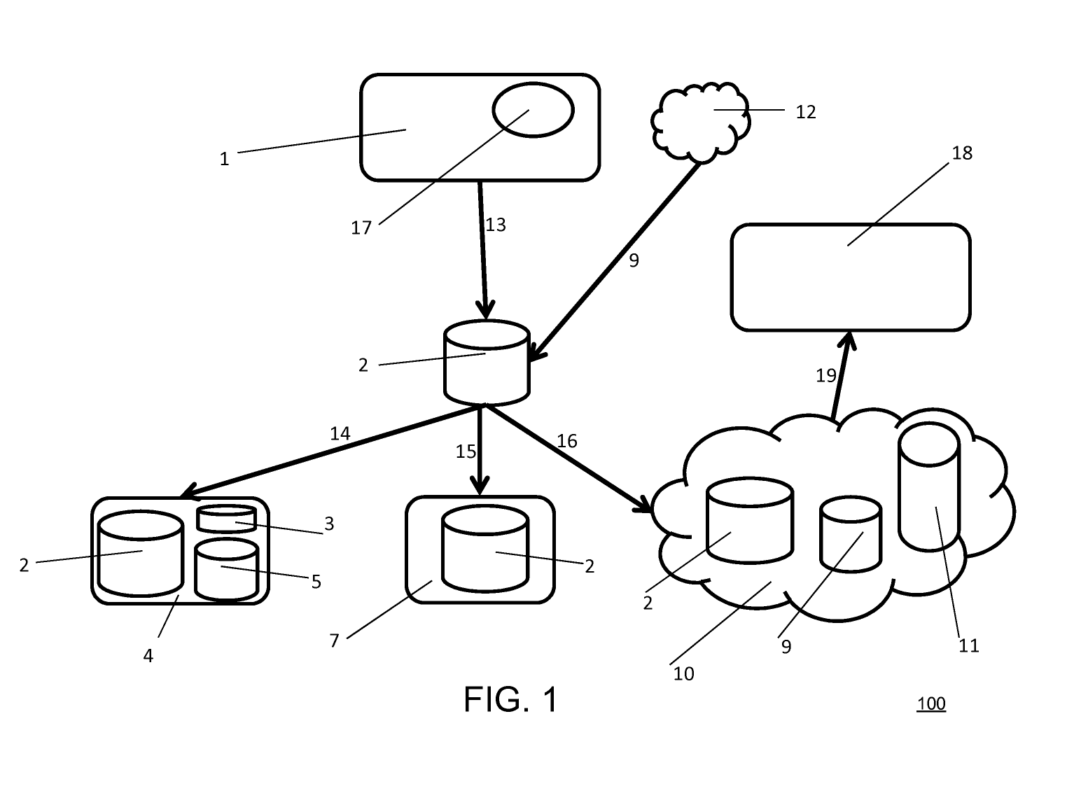

Referring now to the drawings, in FIG. 1 there is shown an illustrative diagram 100 for systems and methods for creating a virtual social and gaming experience. In FIG. 1, an electronic gaming device 1 can be configured to run analytics software 17, for example, separately as an individual application or chat program and the like, as part of an electronic game or chat program, and the like, for example, that is already running on a device 1 (e.g., personal computer (PC), gaming platform, such as PlayStation 3 (PS3) or XBox 360 or Wii platform, iPhone or Andoid or Windows devices, etc.), and the like.

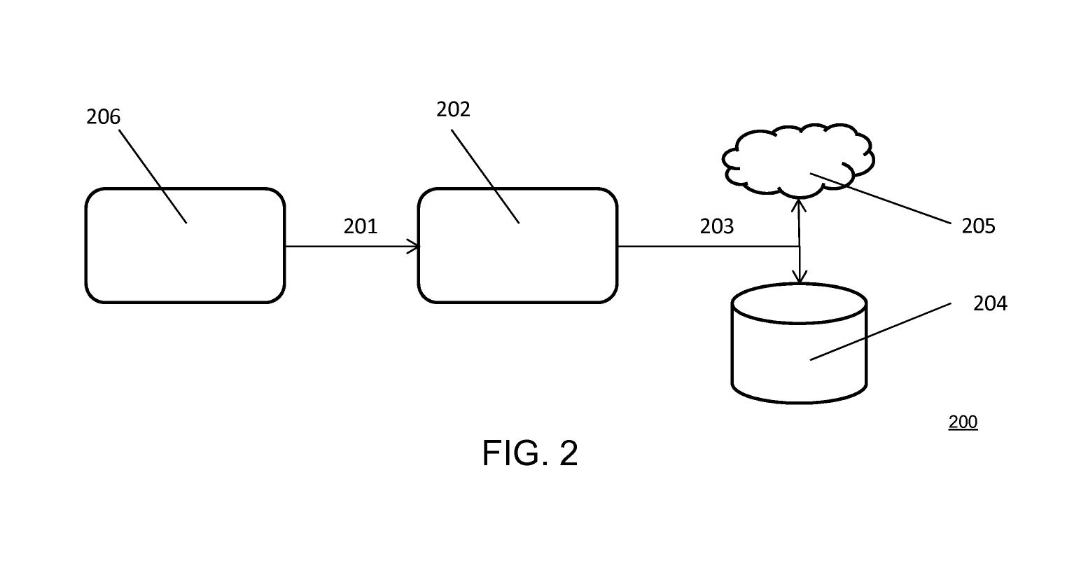

FIG. 2 is an illustrative diagram 200 for systems and methods that monitor and track strengths and weaknesses of a user playing a game (or e.g., chat) and that can store such information locally a device or on a cloud environment, and the like. In FIG. 2, the analytics software 17 can be configured to monitor and track various attributes, for example, such as strengths and weaknesses, and the like, as a user profile 202 of a user playing a game (or e.g., running a chat) program 206 over connection 201 (e.g., a wired or wireless connection) and can store such information, for example, locally on a storage device 204, in a cloud environment 205, and the like, over connection 203 (e.g., a wired or wireless connection). Accordingly, the analytics software 17 can be configured to create user profile data 13, which can be used to create a proxy-player (or e.g., proxy-chatter) 2. The proxy-player (or e.g., proxy-chatter) 2 can also be influenced by other online profiles 12 of the user, for example, based on remotely generated, and the like, data 9.

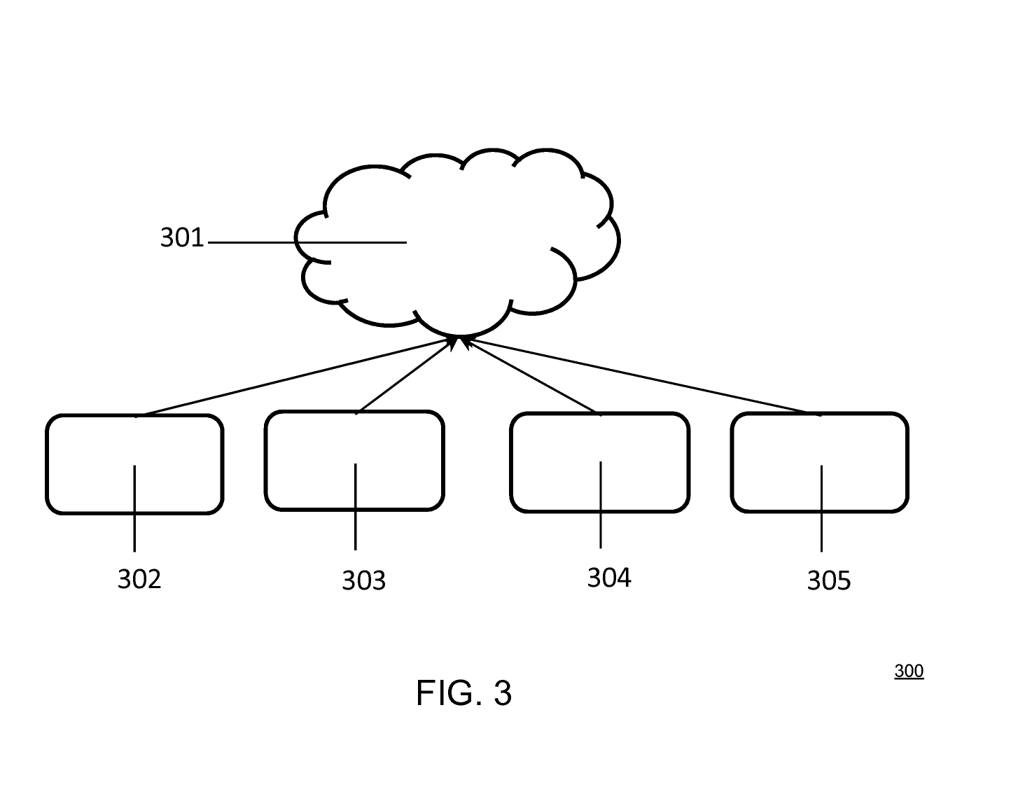

FIG. 3 is an illustrative diagram 300 for systems and methods that allow a proxy-player (or e.g., proxy-chatter) to be influenced by other online profiles of a user, such as social networking data, movies and music interests, and Internet browsing, and the like. In FIG. 3, a few examples of online profiles 301 of a user that can influence a proxy-player include social networking data 302, movies interest 303, music interests 304, Internet browsing 305, and the like.

In an illustrative embodiment, instance of the proxy-player (or e.g., proxy-chatter) 2, for example, instances 14, 15 and 16, can be transferred over a communications system, for example, such as the Internet, and the like, into other devices 4 and 7 (e.g., personal computers (PCs), gaming platforms, such as PlayStation 3 (PS3) or XBox 360 or Wii platforms, iPhone or Andoid or Windows devices, etc.) and/or a cloud environment 10, and the like. The devices 4 and 7 can be different from the device 1. A single device can have one or more different of the proxy-players (or e.g., proxy-chatters) 2. For example, the device 4 can include proxy-players (or e.g., proxy-chatters) 2 and 5. Advantageously, a user of the device 4 can compete in a game or chat with the proxy-player (or e.g., proxy-chatter) 2 or other proxy-players (or e.g., proxy-chatters), even if the user corresponding to the proxy-player (or e.g., proxy-chatter) 2 or the other proxy players is unavailable, has a bad internet connection (e.g., a wired or wireless connection), the devices being used do not match or are incompatible with each other, and the like.

In a further illustrative embodiment, instead of or in addition to actual devices being employed, one or more of the proxy-players (or e.g., proxy-chatters) 2, 9, and 11 can also be aggregated in a cloud environment 10, and the like, that the users can access over the Internet, and the like. Advantageously, users of other devices 18 can connect to the cloud environment 10 over connection 19 (e.g., a wired or wireless connection) and can download an instance of any suitable proxy-player (or e.g., proxy-chatter) to their own device, cloud environment, and the like. Accordingly, instead of transferring proxy-players (or e.g., proxy-chatters) to a local device, the users of such other devices 18 can also compete with the proxy-players (or e.g., proxy-chatters) 2, 9 and 11 over the Internet, a communications network (e.g., a wired or wireless communications network), and the like.

The proxy-players (or e.g., proxy-chatters) can be configured to have complete degrees of freedom, for example, ranging from making moves in a game (or e.g., sending chat phrases) on behalf of the users, expressing feelings and/or communicating with the user and other users or proxy-players (or e.g., proxy-chatters), and the like. In a further illustrative embodiment, the analytic software 17 can be configured to run in a cloud environment, and the like, and can be configured for observing the game or chat, and the like, played or performed on the device 1, instead of running on the device 1.

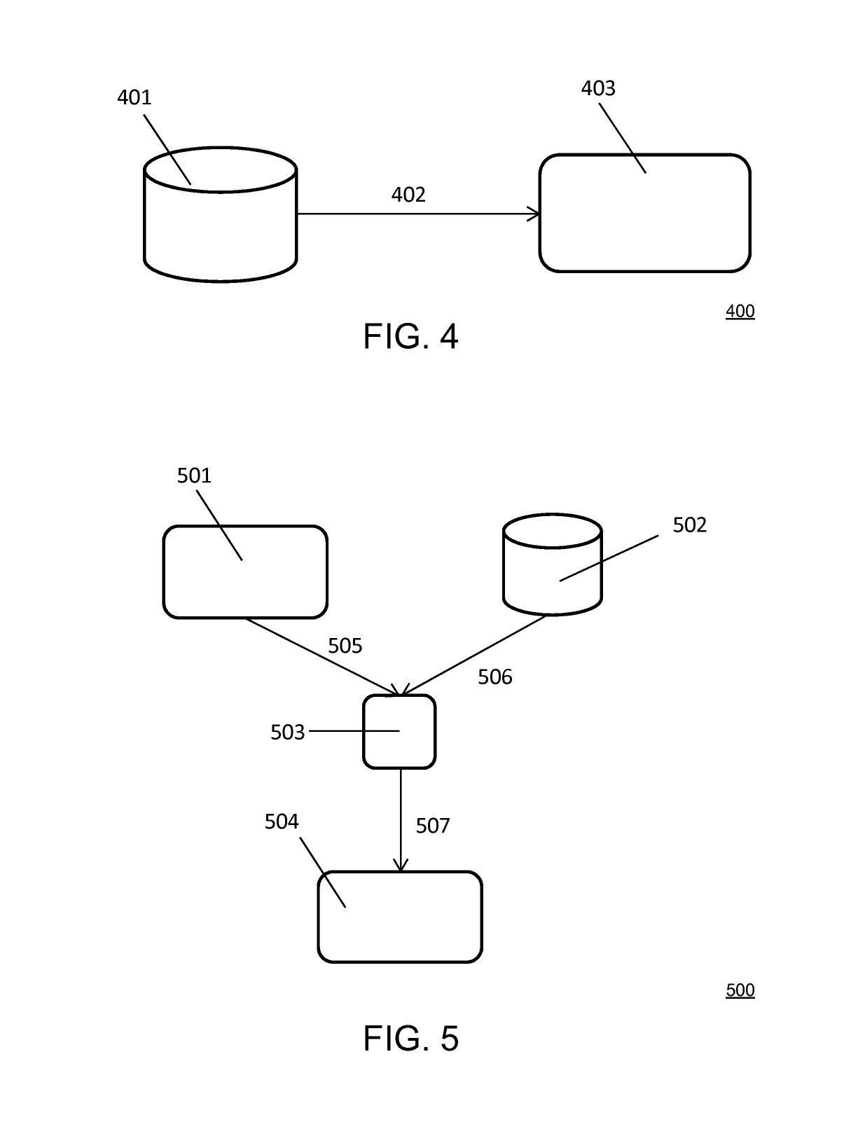

FIG. 4 is an illustrative diagram for systems and methods 400 that allow output of analytics software to be used as an input to a recommendation engine, and the like, that employs personal information of a user as an input. In FIG. 4, the output of the analytics software 17 also can be configured for other purposes. For example, in an illustrative embodiment, such output data 401 can be communicated over a connection 402 (e.g., a wired or wireless connection) and can be used as an input to a recommendation engine 403 or any other suitable engine, and the like, that employs such personal information, and the like, of the user, as an input.

In an illustrative embodiment, the systems and methods can be configured to augment real-time play (or e.g., chat) of the user of the device 1 with the proxy-player (or e.g., proxy-chatter) 2 during the same game (or e.g., chat) to overcome connection issues, for example, such as connection loss or occasional unacceptable high connection latency, and the like, between the device 1 and the device 4 and/or the device 7, for example, at predetermined time intervals, and the like, during the game (or e.g., chat) between players (or e.g., chatters) on the devices 1, 4, and 7. When the network connection is recovered or for example, the latency is back to the acceptable level, and the like, the play (or e.g., chat) of the user of the device 1 can be merged back, replacing the play (or e.g., chat) being conducted by the proxy-player (or e.g., proxy-chatter) 2.

FIG. 5 is an illustrative diagram 500 for systems and methods that that allow a proxy-player (or e.g., a proxy-chatter) to be used when a network connection is unacceptable, such that when the connection is recovered, a real player (or e.g., chatter) can be merged back instead of the proxy-player (or e.g., the proxy-chatter). In FIG. 5, a connection manager 503 can monitor the network connection 505 (e.g., a wired or wireless connection) of a device 501 and connection 507 (e.g., a wired or wireless connection) of a device 504. When the connection is not acceptable for operation (e.g., during gaming or chatting), the connection manager 503 can be configured to switch from a real player (or e.g., real chatter) of the device 501 to a proxy-player (or e.g., proxy-chatter) 502 over connection 506 (e.g., a wired or wireless connection). A proxy-player (or e.g., proxy-chatter) can also be included in the user device 504 or can be instantiated somewhere else, such as on another device, on a cloud environment, and the like.

In an illustrative embodiment, the analytic software 17 can be configured to continuously learn the latest behavior of the user of the device 1 using the proxy player 2, for example, even during play (or e.g., chat), and the like. Advantageously, this can further improve the performance of the proxy-player (or e.g., proxy-chatter) 2, for example, to mimic the latest behavior, and the like, of the user of the device 1.

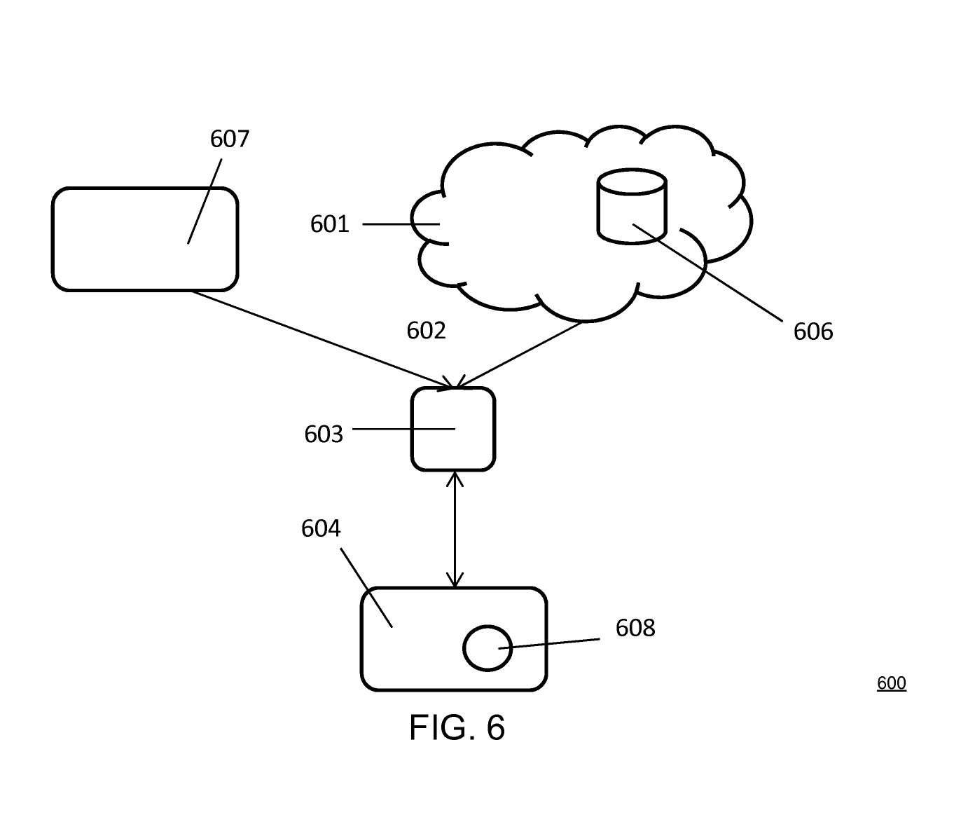

FIG. 6 is an illustrative diagram 600 for systems and methods for updating a proxy-player (or e.g., a proxy-chatter). In FIG. 6, while the user of a device 604 is competing with a proxy-player (or e.g., proxy-chatter) 608, a software-based updating program 603 can be configured to check for an updated version 606 of the proxy-player (or e.g., proxy-chatter) 608 in a cloud environment 601 over connection 602 (e.g., a wired or wireless connection). In an illustrative embodiment, the software-based updating program 603 can be configured for running on device 604. In another illustrative embodiment, the updating program 603 can be configured for running on another device 607, outside of the device 604 and communicating with the device 604 through the communication link 602, and the like. Advantageously, the updated version 606 of the proxy-player (or e.g., proxy-chatter) 608 can be located on the device 604 of the real player (e.g., the creator of the proxy player 608) or on the cloud environment 601.

The above-described devices and subsystems of the illustrative embodiments of FIGS. 1-6 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1-6. The devices and subsystems of the illustrative embodiments of FIGS. 1-6 can communicate with each other using any suitable protocol and can be implemented using one or more programmed computer systems or devices.

One or more interface mechanisms can be used with the illustrative embodiments of FIGS. 1-6, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1-6 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-6 can be implemented via one or more programmed computer systems or devices.

To implement such variations as well as other variations, a single computer system can be programmed to perform the special purpose functions of one or more of the devices and subsystems of the illustrative embodiments of FIGS. 1-6. On the other hand, two or more programmed computer systems or devices can be substituted for any one of the devices and subsystems of the illustrative embodiments of FIGS. 1-6. Accordingly, principles and advantages of distributed processing, such as redundancy, replication, and the like, also can be implemented, as desired, to increase the robustness and performance the devices and subsystems of the illustrative embodiments of FIGS. 1-6.

The devices and subsystems of the illustrative embodiments of FIGS. 1-6 can store information relating to various processes described herein. This information can be stored in one or more memories, such as a hard disk, optical disk, magneto-optical disk, RAM, and the like, of the devices and subsystems of the illustrative embodiments of FIGS. 1-6. One or more databases of the devices and subsystems of the illustrative embodiments of FIGS. 1-6 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-6 can include appropriate data structures for storing data collected and/or generated by the processes of the devices and subsystems of the illustrative embodiments of FIGS. 1-6 in one or more databases thereof.

All or a portion of the devices and subsystems of the illustrative embodiments of FIGS. 1-6 can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-6 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-6, for driving the devices and subsystems of the illustrative embodiments of FIGS. 1-6, for enabling the devices and subsystems of the illustrative embodiments of FIGS. 1-6 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-6. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-6 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

Although the present invention is described in terms of online gaming and chatting, the present invention can be extended to any further suitable social interaction or activity beyond gaming and chatting, as will be appreciated by those of ordinary skill in the relevant art(s).

While the present invention have been described in connection with a number of illustrative embodiments and implementations, the present invention is not so limited, but rather covers various modifications and equivalent arrangements, which fall within the purview of the appended claims.

What is claimed is:

1. A system for multi-player video gaming or chatting, the system comprising:
a virtual representation of a user; and
the virtual representation of the user is configured for being displayed and used on a computer device in place of the user during online and/or offline video gaming, chatting, and/or virtual social interactions.

2. The system of claim 1, wherein the virtual representation of the user is downloaded into a gaming or chatting device to compete or chat on behalf of the user with other real players or other virtual representations of other users.

3. The system of claim 1, wherein the virtual representation of the user is a virtual player in a video game or a virtual chatter in a chatting program.

4. The system of claim 1, wherein the virtual player or the virtual chatter is based on gaming and/or social characteristics of the user.

5. The system of claim 1, wherein the virtual representation of the user is applied to online social interactions, gaming applications, and/or online chatting.

6. A method for multi-player video gaming or chatting, the method comprising:
creating a virtual representation of a user; and
displaying and using the virtual representation of the user on a computer device in place of the user during online and/or offline video gaming, chatting, and/or virtual social interactions.

7. The method of claim 6, wherein the virtual representation of the user is downloaded into a gaming or chatting device to compete or chat on behalf of the user with other real players or other virtual representations of other users.

8. The method of claim 6, wherein the virtual representation of the user is a virtual player in a video game or a virtual chatter in a chatting program.

9. The method of claim 6, wherein the virtual player or the virtual chatter is based on gaming and/or social characteristics of the user.

10. The method of claim 6, wherein the virtual representation of the user is applied to online social interactions, gaming applications, and/or online chatting.

11. A computer program product for multi-player video gaming or chatting, and including one or more computer readable instructions embedded on a non-transitory, tangible computer readable medium and configured to cause one or more computer processors to perform the steps of:
creating a virtual representation of a user; and
displaying and using the virtual representation of the user on a computer device in place of the user during online and/or offline video gaming, chatting, and/or virtual social interactions.

12. The computer program product of claim 11, wherein the virtual representation of the user is downloaded into a gaming or chatting device to compete or chat on behalf of the user with other real players or other virtual representations of other users.

13. The computer program product of claim 11, wherein the virtual representation of the user is a virtual player in a video game or a virtual chatter in a chatting program.

14. The computer program product of claim 11, wherein the virtual player or the virtual chatter is based on gaming and/or social characteristics of the user.

15. The computer program product of claim 11, wherein the virtual representation of the user is applied to online social interactions, gaming applications, and/or online chatting.
